(19) United States
(12) Patent Application Publication
(10) Pub. No.: US 2013/0155197 A1
(43) Pub. Date: Jun. 20, 2013

(54) STEREO IMAGE CAPTURING DEVICE

(71) Applicants: HO-KAI LIANG, Tu-Cheng (TW); CHIEN-WEI HUANG, Tu-Cheng (TW)

(72) Inventors: HO-KAI LIANG, Tu-Cheng (TW); CHIEN-WEI HUANG, Tu-Cheng (TW)

(73) Assignee: HON HAI PRECISION INDUSTRY CO., LTD., Tu-Cheng (TW)

(21) Appl. No.: 13/523,896

(22) Filed: Jun. 15, 2012

(30) Foreign Application Priority Data
Dec. 16, 2011 (TW) 100146909

(51) Int. Cl. H04N 13/02

(52) U.S. Cl. 348/47; 348/E13.074

(57) ABSTRACT

A stereo image capturing device includes two image capturing modules, an image processing unit, a storage unit storing the image processing unit and a processor for executing the image processing unit. Each image capturing module includes a lens unit and an image sensor. The image processing unit includes a WDF module, a focus control module, and an image synthesize module. The WDF module determines the sharpness of the colors in images detected by the image sensor and acquires object distances of the images according to the sharpness. When the object distance is bigger than a predetermined distance, the WDF module can modify the sharpness of the images, otherwise the focus control module drives the lens unit to change focal distance of the lens unit. The image synthesize module synthesizes the images into stereo images.

### TECHNICAL FIELD

The present disclosure relates to digital image capturing devices, particularly to a stereo image capturing device.

### DESCRIPTION OF RELATED ART

Width Depth Field (WDF) technology is used in the field of digital image capture. By using this technology, different sharpnesses corresponding to different colors of the image are determined, a sharpest color is selected, and the sharpnesses of the other colors are modified according to the sharpness of the sharpest color. In this way, a clear image is obtained without changing the focal length of an image capturing device.

Yet, when the distance to the object is too small, for example, is smaller than 400 millimeters (mm), the sharpness of all colors is unacceptably bad and cannot be used by WDF technology to make the image clear.

What is needed, therefore, is a stereo image capturing device which can overcome the limitations mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a functional diagram of a stereo image capturing device according to an embodiment, the stereo image capturing device including two image capturing modules.

FIG. 2 is a functional diagram showing the stereo image capturing device of FIG. 1 connected to a stereo television.

FIG. 3 is a schematic, isometric view of an image capturing module of FIG. 1, the image capturing module including a lens unit.

FIG. 4 is a sectional view along line IV-IV of the image capturing module of FIG. 3.

FIG. 5 is an exploded view of the image capturing module of FIG. 3 without the lens unit.

### DETAILED DESCRIPTION

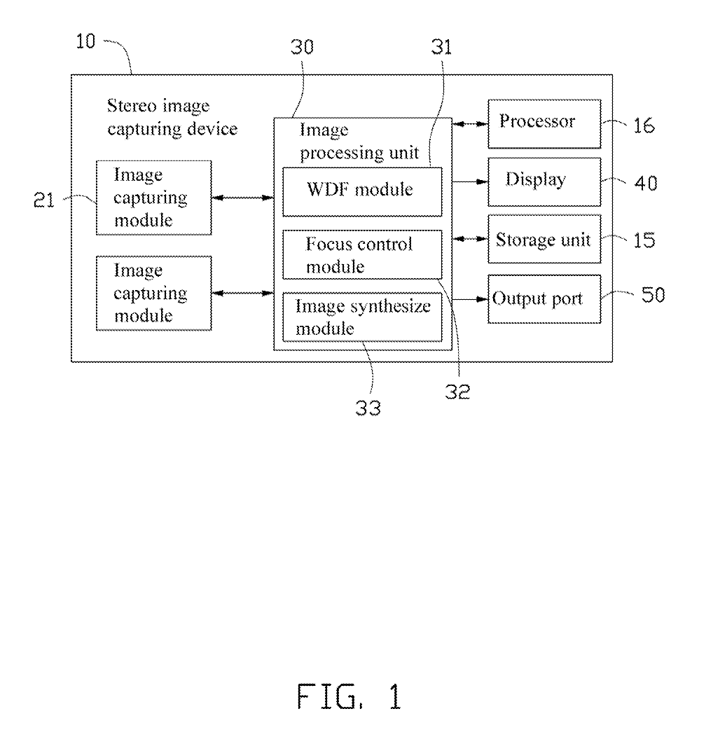

Referring to FIG. 1, a stereo image capturing device 10 according to an embodiment is shown. In this embodiment, the stereo image capturing device 10 is a mobile phone. The stereo image capturing device 10 includes two image capturing modules 21, an image processing unit 30, a storage unit 15, a processor 16, a display 40, and an output port 50. One or more computerized codes of the image processing unit 30 may be stored in the storage unit 15 and executed by the processor 16.

The two image capturing modules 21 capture images of one object from different viewing angles and send the captured images to the image processing unit 30. The image processing unit 30 synthesizes the images from the two image capturing devices 21 to form a stereo image. For getting a good stereo image, the distance between the centers of the two image capturing devices 21 is in the range of 25 mm to 40 mm, optimally at 32.5 mm. As the stereo image capturing/synthesizing technology is familiar to one skilled in the art, a detailed description is omitted here.

The image processing unit 30 communicates with the image capturing modules 21, the display 40 and the output port 50. In this embodiment, the image processing unit 30 communicates with the image capturing modules 21 via a Mobile Industry Processor Interface (MIPI).

The image processing unit 30 includes a Width Depth Field (WDF) module 31, a focus control module 32, and an image synthesizing module 33.

The WDF module 31 receives the captured images from the image capturing modules 21. The captured images each have at least two colors. In this embodiment, the captured images have three colors such as a red, a green, and a blue. There is a relationship between the object distance (the distance between the object being captured and the image capturing device 10) and the sharpness of a color. The WDF module 31 determines the sharpness of the colors and acquires the object distance d according to the sharpness of a color, for example, the sharpness of the color red. The WDF module 31 then determines whether the object distance d is bigger than a predetermined distance D. In this embodiment, the predetermined distance D is about 400 mm. If the object distance d is bigger than the predetermined distance D, the WDF module 31 modifies the sharpness of the colors contained in the captured images to achieve two first clear images. The sharpness modifying method is described in a U.S. patent application publication NO. 2008/0158377, entitled Method Of Controlling An Action, Such As A Sharpness Modification, Using A Color Digital Image. The WDF module 31 sends the two first clear images to the image synthesize module 33. The image synthesize module 33 synthesizes the two first clear images into a first stereo image.

When the object distance d is equal to or smaller than the predetermined distance D, the WDF module 31 sends the value of the object distance d to the focus control module 32. The focus control module 32 drives the image capturing modules 21 to focus on the object. The image capturing modules 21 then can achieve two second clear images. Then the image synthesize module 33 synthesizes the two second clear images into a second stereo image.

The image synthesize module 33 sends the first or second stereo image to the display 40 and the output port 50. The display 40 shows the first or second stereo image. The first or second stereo image can be further sent to a stereo television or a computer via the output port 50. In this embodiment, the output port 50 is a High Definition Multimedia Interface (HDMI).

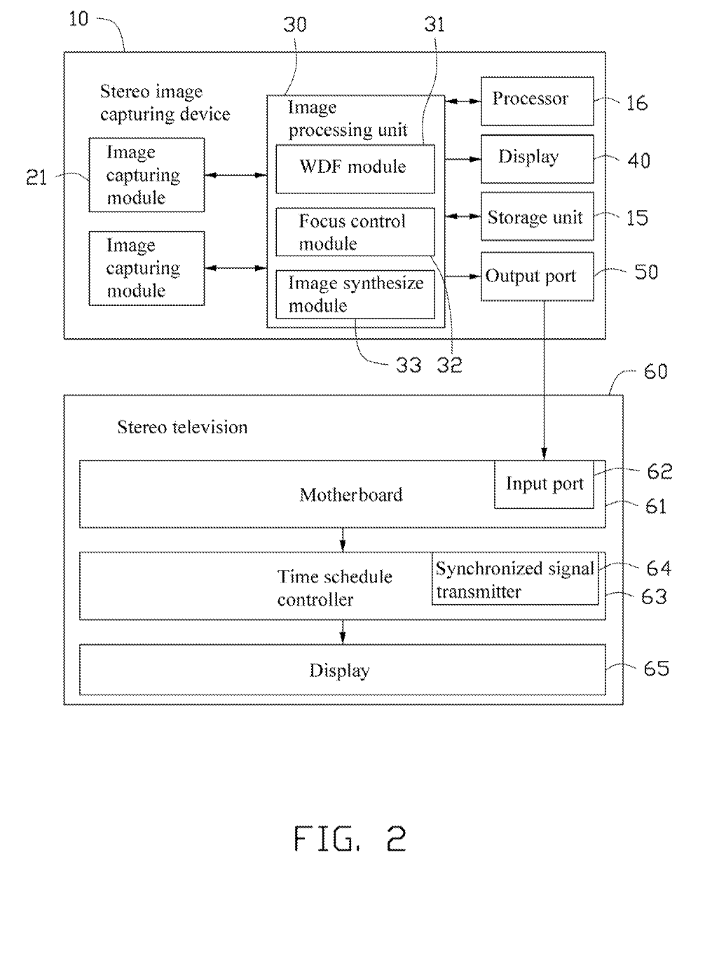

Referring to FIG. 2, a stereo television 60 connected to the stereo image capturing device 10 is shown. The stereo television 60 includes a motherboard 61, a time schedule controller 63, and a display 65. The motherboard 61 includes an input port 62 communicating with the output port 50. The input port 62 is a HDMI in this embodiment. The time schedule controller 63 includes a synchronized signal transmitter 64. The motherboard 61 receives the first or second stereo image, resolves the first or second stereo image into a left eye image and a right eye image, and sends the left eye image and the right eye image to the time schedule controller 63. The time schedule controller 63 sends the left eye image and the right eye image to the display 65 in series. The synchronized signal transmitter 64 may send a synchronized signal to a pair of liquid crystal glasses worn by a user (not shown), for ensuring that when the left eye image is shown on the display 65, the right eye lens of the glasses is cut off and the user can only observe the display 65 before the left eye, and when the right eye image is shown on the display 65, the left eye lens of the glasses is cut off and the user can only observe the display 65 before the right eye. In this way, the user observes different images in the left eye and in the right eye and synthesizes the images to a stereo image in the brain.

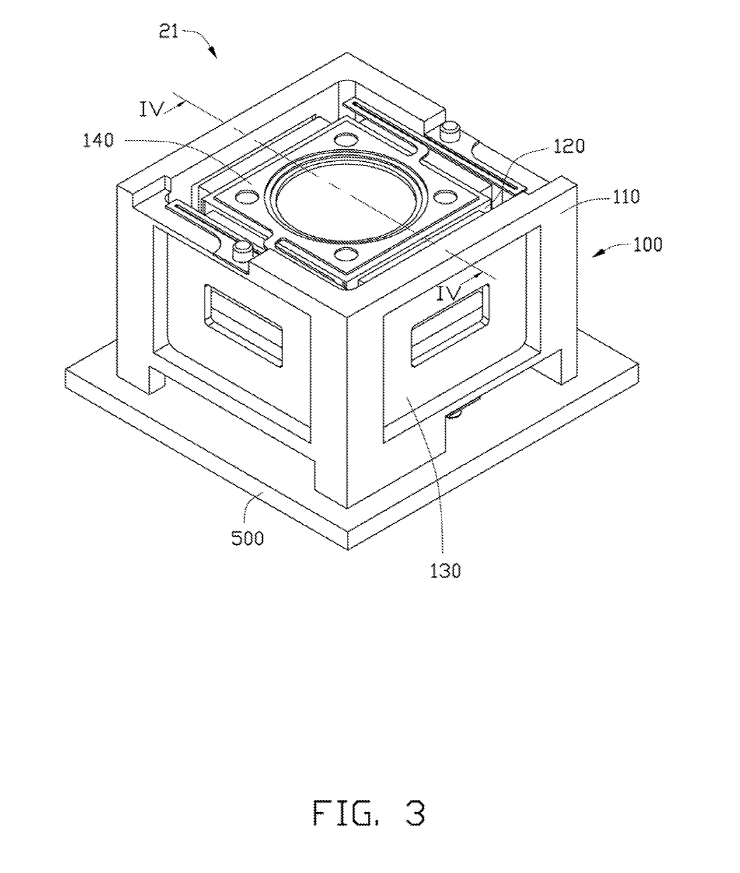

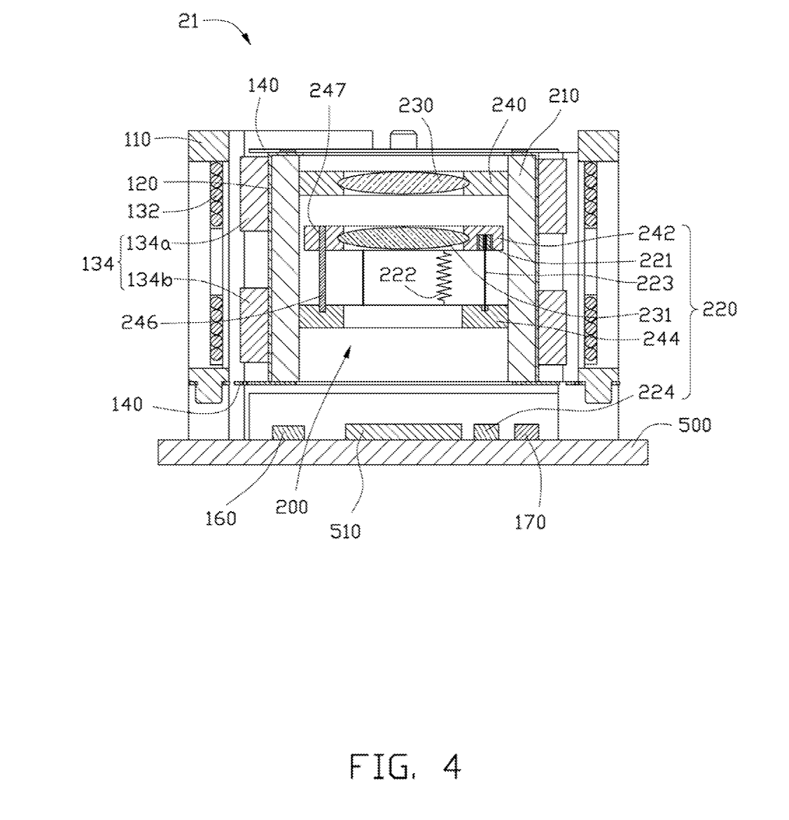

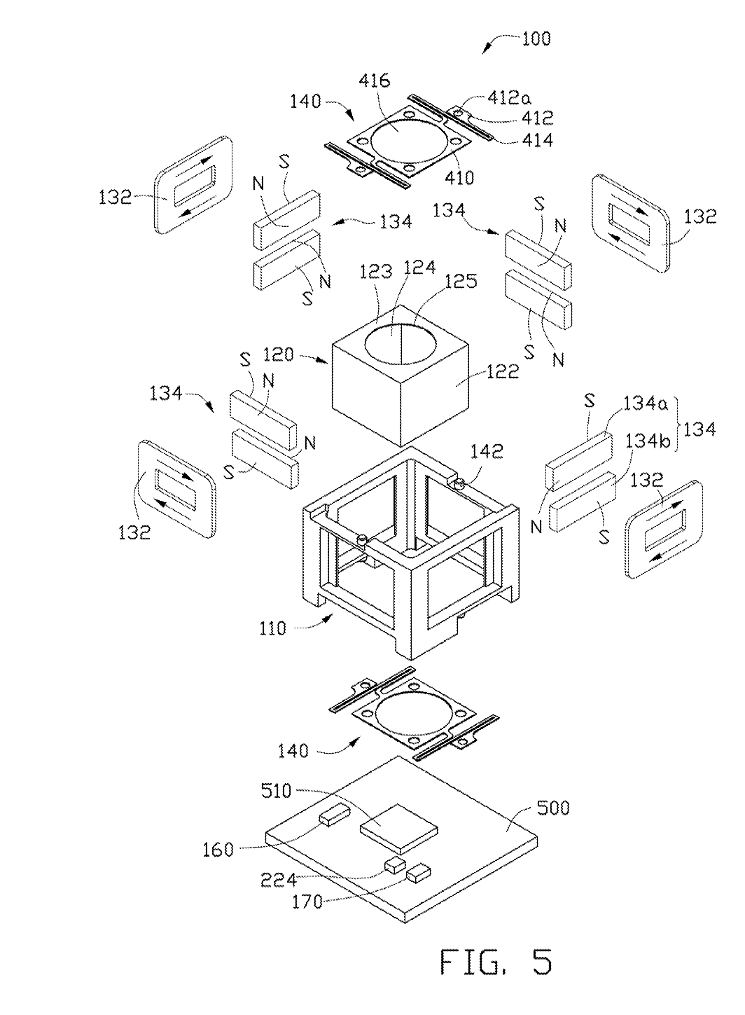

Referring to FIGS. 3-5, each of the image capturing modules 21 includes an image stabilizer 100, a lens unit 200, a circuit board 500, and an imaging sensor 510 fixed on and electrically connected to the circuit board 500. The imaging sensor 510 is aligned with the lens unit 200 for sensing light passing through the lens unit 200 for capturing an image. The captured image has at least two kinds of colors.

The lens unit 200 includes a barrel 210, a lens driving assembly 220, a first lens 230, and a first securing element 240. The first securing element 240 is ring-shaped, with the first lens 230 therein. The first securing element 240 is fixed to the inner surface of the barrel 210 by glue.

The lens driving assembly 220 includes a second lens 231, a second securing element 242, a fixing element 244, a number of resistors 221, a number of resilient elements 222, a number of shape memory alloy (SMA) elements 223, and a power chip 224.

The second securing element 242 is ring shaped, with the second lens 231 therein. The outer diameter of the second securing element 242 is smaller than the inner diameter of the lens barrel 110, such that the securing element 242 and the second lens 231 can slide inside the lens barrel 110. The second securing element 242 defines axial guide holes 247. The fixing element 244 is ring shaped. The fixing element 244 is fixed to the inner surface of the barrel 210 by glue. Guide poles 246 protrude from the fixing element 244 in a direction parallel to an optical axis of the image capturing module 21 and are slidably inserted into the guide holes 247.

The resistors 221 are mounted in the second securing element 242 and are electrically connected to the power chip 224. Each of the SMA elements 223 includes two ends. One end of each SMA element 223 is attached to one of the resistors 221, and the other end is attached to the fixing element 244. The SMA elements 223 are evenly spaced from each other.

Each of the resilient elements 222 includes two ends. One end of each resilient element 222 is attached to the second securing element 242, and the other end attached to the fixing element 244. The resilient elements 222 are evenly spaced from each other.

The power chip 224 is configured for supplying a current to the resistors 221, such that the connected SMA elements 223 can be heated.

The SMA elements 223 have a preset shape which is assumed during heating, or in higher ambient temperatures. In the present embodiment, the SMA elements 223 become straight at high temperatures. In operation, the internal spaces between the first lens 230 and the second lens 231, and the imaging sensor 510 can be adjusted by combination of the SMA elements 223 and the resilient elements 222. When a current is supplied to the resistors 221, the resistors 221 transmit the heat generated thereby to the SMA elements 223. Once the heat generated by the resistors 221 reaches or exceeds the point of martensitic transformation, the SMA elements 223 change shape, from bent to straight, moving the second lens 231 towards the first lens 230 correspondingly. When heat generated by the resistors 221 is below the point of martensitic transformation, the resilient elements 222 pull the second lens 231 towards the fixing element 244. Thereby, the lens unit 200 can perform autofocus or auto-zoom functions.

Referring back to FIG. 1, when the object distance d is equal to or smaller than the predetermined distance D, the WDF module 31 sends the value of the object distance d to the focus control module 32. The focus control module 32 drives the lens units 200 of the image capturing modules 21 to focus on the object, to achieve the two second clear images.

The image stabilizer 100 includes a stationary supporting frame 110, a moveable frame 120, a driving assembly 130, two resilient sheets 140, a controller 160, and a displacement sensor 170.

The stationary supporting frame 110 is fixed to the circuit board 500. The stationary supporting frame 110 is substantially cuboid. The moveable frame 120 is substantially a hollow cube. The moveable frame 120 is moveably received in the stationary supporting frame 110 and spaced from the stationary supporting frame 110.

The moveable frame 120 defines a receiving space 124 therein. The moveable frame 120 includes four side surfaces 122 and two end surfaces 123. The four side surfaces 122 are connected perpendicularly end to end. The two end surfaces 123 connect with the four side surfaces 122. The end surfaces 123 define light holes 125 in communication with the receiving space 124. The lens unit 200 is received in the receiving space 124.

Each resilient sheet 140 includes a moveable portion 410, two stationary portions 412 and two bent portions 414 extending from opposite sides of the moveable portion 410. The bent portions 414 connect the moveable portion 410 and the stationary portions 412. The shape of the moveable portion 410 is substantially the same as that of the end surface 123. The moveable portion 410 defines a through hole 416 aligned with the light hole 125. The moveable portion 410 is fixedly attached to the end surface 123 and moves together with the moveable frame 120.

The stationary portions 412 define positioning holes 412a. The stationary supporting frame 110 includes positioning posts 142. The positioning posts 142 extend through the positioning holes 412a so that the resilient sheets 410 are fixed on the stationary supporting frame 110. Therefore, the moveable frame 120 is elastically supported in the stationary supporting frame 110 by the resilient sheets 410.

The driving assembly 130 includes coils 132 positioned on the stationary supporting frame 110 and magnet pairs 134 positioned on the moveable frame 120. Each coil 132 faces one of the magnet pairs 134. The driving assembly 130 is configured for driving the moveable frame 120 to rotate relative to the stationary supporting frame 110 through magnetism between the coils 132 and the magnet pairs 134.

In detail, the number of the coils 132 is four. Each coil 132 is substantially a ring, but rectangular.

The number of the magnet pairs 134 is four. The four magnet pairs 134 are fixed on the side surfaces 122 of the movable frame 120. Each magnet pair 134 includes an upper magnet 134a and a lower magnet 134b. A magnetic pole of the upper magnet 134a facing a coil 132, for example, magnetic north is opposite to a magnetic pole of the lower magnet 134b facing the coil 132, for example magnetic south.

The displacement sensor 170 is attached to the circuit board 500. The displacement sensor 170 may be, for example, a laser displacement sensor 170, and is configured for detecting vibration or movement of the moveable frame 120 when the stereo image capturing device 10 experiences vibration or movement. Since the lens unit 200 is received in the moveable frame 120, any vibration or movement of the lens unit 200 is also detected.

The controller 160 is configured for controlling the driving assembly 130 to drive the moveable frame 120 to rotate according to any detected vibration or movement of the moveable frame 120. In this embodiment, the controller 160 selectively applies currents to the coils 132 according to the vibration or movement of the moveable frame 120. Therefore, the lens unit 200 with the moveable frame 120 is driven to rotate to compensate for the vibration or movement by interaction between the electrified coils 132 and the magnet pairs 134.

When the object distance d is not bigger than the predetermined distance D, the stereo image capturing device 10 uses the SMA elements 223 to adjust the focus of the two image capturing modules 21, in this way, clear images are also achieved even when the object distance is too small (as hereinbefore defined), and the shortcoming of the WDF technology is overcome. Furthermore, the image stabilizer 100 is used to compensate for the vibration or movement of the image capturing modules 21, thus, the quality of the images captured is further enhanced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A stereo image capturing device, comprising:
two image capturing modules, each image capturing module comprising:
a lens unit comprising:
a barrel;
a fixing element fixed in the barrel;
a securing element moveably received in the barrel;
a lens received in the securing element;
a number of resilient elements connected between the fixing element and the securing element;
a number of shape memory alloy (SMA) elements connected between the fixing element and the securing element;
a number of resistors, each resistor coupled to a respective one of the SMA elements; and
a power chip electrically connected to the resistors; and
an image sensor aligned with the lens, the image sensor configured for capturing images with at least two kinds of colors;
a storage unit;
a processor; and
an image processing unit stored in the storage unit and configured for being executed by the processor, the image processing unit comprising:
a WDF module;
a focus control module; and
an image synthesize module, the WDF module configured for determining the sharpness of the colors of the images and acquiring object distance of the images according to the sharpness; wherein
when the object distance is bigger than a predetermined distance, the WDF module modifies the sharpness of the images to get first clear images; when the object distance is equal to or smaller than the predetermined distance, the WDF module sends the object distance to the focus control module, the focus control module drives the power chip to supply current to the resistors to change the focal distance of the lens unit, whereby image sensors of the two image capturing modules acquire second clear images; the image synthesize module is configured for synthesizing the first clear images to first stereo images or synthesizing the second clear images to second stereo images.

2. The stereo image capturing device of claim 1, wherein the securing element defines guide holes, the fixing element comprises guide poles extending in a direction parallel to an optical axis of the image capturing module, the guide poles are moveably inserted into the guide holes.

3. The stereo image capturing device of claim 1, wherein the predetermined distance is 400 millimeters.

4. The stereo image capturing device of claim 1, further comprising an output port, the image synthesize module sending the first stereo images or the second stereo images to the output port.

5. The stereo image capturing device of claim 4, wherein the output port is a HDMI.

6. The stereo image capturing device of claim 5, wherein the HDMI is configured for connecting to a stereo television.

7. The stereo image capturing device of claim 1, wherein a distance between two centers of the two image capturing modules is in the range from 25 millimeters to 40 millimeters.

8. The stereo image capturing device of claim 7, wherein the distance between the two centers of the two image capturing modules is 32.5 millimeters.

9. The stereo image capturing device of claim 1, wherein each image capturing module further comprises an image stabilizer, the image stabilizer comprising:
a stationary supporting frame;
a moveable frame moveably received in the stationary supporting frame and spaced from the stationary supporting frame, the moveable frame holding the lens unit;
a driving assembly comprising coils and magnet pairs, the coils positioned on the stationary supporting frame, the magnet pairs positioned on the moveable frame and facing the coils, the driving assembly configured for driving the moveable frame to rotate relative to the stationary supporting frame through interaction between the coils and the magnet pairs; and
two resilient sheets interconnecting the stationary supporting frame and the moveable frame.

10. The stereo image capturing device of claim 9, wherein the moveable frame comprises four side surfaces, the magnet pairs are positioned on the four side surfaces.

11. The stereo image capturing device of claim 9, wherein each resilient sheet comprises a moveable portion, two stationary portions and two bent portions, the moveable portion is positioned on the moveable frame, the stationary portions are positioned on the stationary supporting frame, the two bend portions are positioned at two opposite sides of the moveable portion, each of the bent portions connects the moveable portion to a respective one of the stationary portions.

12. The stereo image capturing device of claim 9, wherein the image stabilizer further comprises a displacement sensor configured for detecting vibration of the moveable frame.

13. The stereo image capturing device of claim 12, wherein the image stabilizer further comprises a controller configured for applying currents to the coils according to the detected vibration of the moveable frame, the lens unit with the moveable frame being driven to compensate the vibration by interaction between the electrified coils and the corresponding magnet pairs.
